(19) United States
(12) Patent Application Publication
(10) Pub. No.: US 2026/0288953 A1
(43) Pub. Date: Sep. 24, 2026

(54) SECURITY EVENT ROOT CAUSE DETERMINATION FOR CONTAINERIZED SOFTWARE APPLICATIONS

(71) Applicant: Microsoft Technology Licensing, LLC, Redmond, WA (US)

(72) Inventors: Josef WEIZMAN, Petah Tikva (IL); Ram Haim PLISKIN, Tel Aviv (IL); Lior LEIZEROVICH, Givatayim (IL)

(21) Appl. No.: 19/085,359

(22) Filed: Mar. 20, 2025

(51) Int. Cl. G06F 21/56; G06F 21/53

(52) U.S. Cl. CPC G06F 21/562; G06F 21/53

(57) ABSTRACT

Containerized applications are common in modern software development. However, mitigating security events in containerized environments can be complex because malicious interactions with containerized applications may occur at several levels in a containerized application computing environment—e.g., at the container image level, at the cloud administration level, at the orchestration level, at the container runtime level, etc. This disclosure describes determining the root cause of a security event associated with a containerized software application by successively advancing through a series of steps, starting at the container image level and continuing through the container runtime level, until the root cause is identified. Determining the root cause includes correlating data indicative of possible malicious interactions with the containerized application at these several levels to facilitate effective mitigation of an attack.

### BACKGROUND

This disclosure relates to security event root cause determination for containerized software applications.

A containerized software application is a software application that runs inside a lightweight, portable, and isolated computing environment called a container. The container includes the application's code, runtime, libraries, dependencies, and other components. The container is configured to ensure that the software application runs consistently across different computing systems such as desktop computers, laptop computers, tablet computers, cloud computing systems, etc.

### SUMMARY

Containerized software applications are common in modern software development. However, mitigating security events in containerized environments can be complex because malicious interactions with containerized applications may occur at several levels in a containerized application computing environment—e.g., at the container image level, at the cloud administration level, at the orchestration level, at the container runtime level, etc. This disclosure describes determining the root cause of a security event associated with a containerized software application by successively advancing through a series of steps, starting at the container image level and continuing through the container runtime level, until the root cause is identified. Determining the root cause includes correlating data indicative of possible malicious interactions with the containerized application at these several levels to facilitate effective mitigation of an attack.

Some embodiments include a method for determining a root cause of a security event associated with a containerized software application. The method comprises (a) determining whether an instance of a malicious process is present in an image of a container running the containerized software application; (b) determining whether the instance of the malicious process is present in an orchestration object configured to run the container; (c) determining whether the instance of the malicious process was initiated by a code execution command associated with the orchestration object; (d) determining whether the instance of the malicious process was initiated by a cloud level command; (e) determining whether the instance of the malicious process resulted from a runtime exploitation based on timing of the security event relative to a container start time; determining the root cause of the security event associated with the containerized software application by successively advancing through one or more of (a)-(e); and facilitating execution of a security patch based on the root cause.

In some embodiments, the security event is a security alert. The security alert comprises an automated notification generated in response to a detected security threat associated with the containerized software application.

In some embodiments, the method comprises receiving and analyzing the security alert to detect the instance of the malicious process.

In some embodiments, the containerized software application comprises software code that runs inside the container. The container comprises an isolated environment configured to ensure the software code runs consistently across different computing systems. The different computing systems comprise one or more of a local desktop, laptop, or tablet computer; a virtual machine; a data center; a cloud computing system; or an edge computing system.

In some embodiments, the instance of the malicious process includes ancestors of the malicious process.

In some embodiments, the image of the container comprises a static electronic file comprising elements needed to run the containerized application, including code, dependencies, libraries, and runtime.

In some embodiments, determining whether the instance of the malicious process is present in the image of the container running the containerized software application comprises analyzing layers of the image of the container to identify entry points and arguments in the image layers, and determining whether the instance of the malicious process appears in an entry point or in the arguments in the image layers, and if so, determining the root cause is associated with the image of the container.

In some embodiments, determining whether the instance of the malicious process is present in an orchestration object configured to run the container comprises determining a configuration of the orchestration object, identifying an entry point and arguments in the configuration of the orchestration object, and determining whether the instance of the malicious process appears in the entry point or in the arguments of the orchestration object, and if so, determining the root cause is associated with the orchestration object.

In some embodiments, determining the configuration of the orchestration object comprises querying an orchestration application program interface (API) to retrieve the configuration of the orchestration object.

In some embodiments, the orchestration object is a pod. The pod comprises a logical host for one or more containerized applications. The pod includes one or more containers, along with shared networking and storage resources for the one or more containers.

In some embodiments, the code execution command comprises an exec command configured to facilitate a user run command on the container. Determining whether the instance of the malicious process was initiated by the code execution command associated with the orchestration object comprises searching an orchestration API log for a period of time prior to the security event for the exec command. Responsive to the exec command being found in the orchestration API log, the root cause is determined to be associated with the code execution command.

In some embodiments, determining whether the instance of the malicious process was initiated by the code execution command associated with the orchestration object comprises determining which user executed the exec command based on the exec command found in the orchestration API log.

In some embodiments, determining whether the instance of the malicious process was initiated by a cloud level command comprises searching a cloud provider API log for a period of time prior to the security event for a cloud-native run command operation comprising the instance of the malicious process. Responsive to the cloud-native run command being found in the cloud provider API log, the root cause is determined to be associated with the cloud level command.

In some embodiments, determining whether the instance of the malicious process was initiated by a cloud level command comprises determining which cloud user executed the cloud-native run command operation based on the cloud level command found in the cloud provider API log.

In some embodiments, determining whether the instance of the malicious process resulted from the runtime exploitation comprises determining a time difference between the timing of the security event and the container start time. Responsive to the time difference breaching a threshold, the root cause of the security event is determined to be a runtime exploitation.

In some embodiments, facilitating execution of the security patch based on the root cause comprises outputting the root cause of the security event. The outputting indicates one or more of (1) an origin of the malicious process, (2) recommended mediation steps to mitigate a threat posed by the malicious process, and (3) recommended mediation steps to mitigate a future threat posed by the malicious process.

Some embodiments include a tangible, non-transitory, machine-readable memory storing instructions that, when executed by a data processing apparatus such as a processor, cause the data processing apparatus to perform one or more described operations.

Some embodiments include a system comprising one or more processors, memory, or other components. The memory stores instructions that, when executed by the one or more processors, effectuate one or more described operations.

### BRIEF DESCRIPTION OF THE DRAWINGS

The above-mentioned aspects and other aspects of the present techniques will be better understood when the present application is read in view of the following figures in which like numbers indicate similar or identical elements.

FIG. 1A is a logical-architecture block diagram that illustrates a system configured for determining a root cause of a security event associated with a containerized software application.

FIG. 1B illustrates a second potential embodiment of the system shown in FIG. 1A.

FIG. 1C illustrates a third potential embodiment of the system shown in FIGS. 1A and 1B.

FIG. 1D illustrates a fourth potential embodiment of the system shown in FIG. 1A, FIG. 1B, and FIG. 1C.

FIG. 2 illustrates several levels in a containerized application computing environment.

FIG. 3 illustrates an example flow of operations performed by one or more of the systems shown in FIG. 1A-FIG. 1D.

FIG. 4 illustrates different example embodiments of a method for determining a root cause of a security event associated with a containerized software application.

### DETAILED DESCRIPTION OF CERTAIN EMBODIMENTS

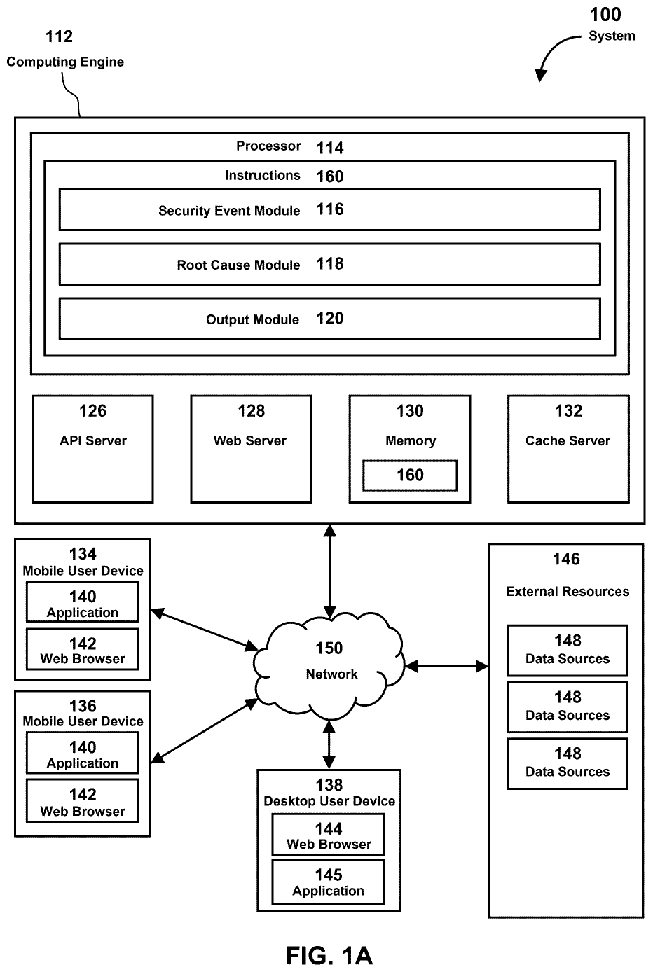

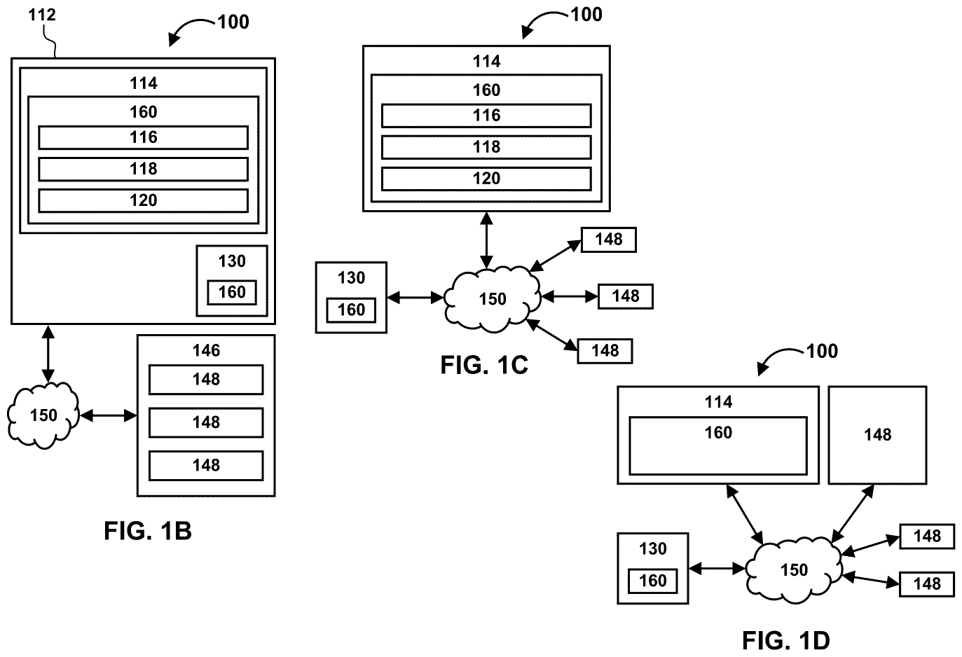

FIG. 1A illustrates a system 100 comprising a computing engine 112 and other components configured for determining a root cause of a security event associated with a containerized software application.

A software application comprises a software-based program or system designed to perform specific functions or provide services when executed on a computing device. A software application may operate on various platforms, including desktop computers, mobile devices, embedded systems, web browsers, or in cloud-based environments. The application may interact with external systems, such as databases, APIs (application programming interfaces), or network services, to provide its functionality. A software application may be implemented as standalone software, a distributed system, or some combination thereof. For example, in some embodiments, the application may operate locally on a user's device, while in others, it may rely on communication with remote servers for processing or data access.

A container comprises an isolated environment configured to ensure software code runs consistently across different computing systems. The isolated environment comprises a self-contained runtime space in which a containerized application operates independently from the underlying host system and other containers. This isolation is achieved through various operating system-level mechanisms, or other mechanisms. The isolated environment ensures that the application within the container runs with its own code, runtime, libraries, dependencies, configurations, file system, or other components, minimizing conflicts with other applications and enhancing security, portability, and consistency across different deployment environments. A containerized software application runs inside such a container. The different computing systems may comprise one or more of a local desktop, laptop, or tablet computer; a virtual machine; a data center; a cloud computing system; or an edge computing system, for example.

With containerized software applications, individual containers run independently from others and from a host computing system. Containers can run across different operating systems and cloud environments without modification. Containers often share a host operating system (OS) kernel, making them relatively lightweight and efficient compared to other software applications. Containers can be easily deployed, scaled up or down, and orchestrated using tools like Kubernetes, for example. Containers also start quickly compared to traditional applications because they do not typically require a full OS boot. Example containerized software applications may include web applications (e.g., WordPress), databases (e.g., MySQL/Postgre SQL), application development tools (e.g., GitLab), microservice applications and application programming interfaces (API's) (e.g., streaming application operating systems, REST API's), artificial intelligence and machine learning applications (e.g. self-hosted LLM models), cloud native and serverless applications (e.g. Jupiter notebooks), messaging applications, edge computing and IoT (internet of things) applications, blockchain applications, cryptocurrency applications, or other containerized software applications.

In general, a security event in the context of a containerized application comprises any detected occurrence, condition, or activity that may impact the security of the containerized software application. These events can include security threats, alerts, vulnerabilities, anomalies, policy violations, or unauthorized access attempts, as several examples. Security events may trigger automated notifications, warnings, or advisories—e.g., security alerts configured to inform system administrators, automated security mechanisms, or other entities about potential risks that could compromise a containerized software application and any of its associated resources. In some embodiments, for example, a security event comprises a security alert, or other security events. A security alert comprises an automated notification generated in response to a detected security threat associated with a containerized software application.

A root cause comprises one or more fundamental underlying factors or origins of a security event. The root cause is the primary reason why a security occurs, rather than just its immediate symptoms or effects. The root causes of security events in containerized applications can arise from malicious processes or from other sources. A malicious process (or activity) is a running instance of a program or code configured to perform unauthorized, harmful, or deceptive actions associated with a containerized software application. These processes or activities can originate from malware, compromised applications, unauthorized scripts, or exploited vulnerabilities and may operate with the intent to steal data, disrupt system functionality, escalate privileges, gain unauthorized control over resources, etc.

Malicious processes may take advantage of misconfigurations, software vulnerabilities, unauthorized access privileges, operational failures, a combination of two or more of these, or other occurrences. Misconfigurations (e.g., excessive access privilege permissions, exposed sensitive data, unrestricted network reachability etc.) can create security gaps that malicious processes can exploit. Software vulnerabilities within container images, libraries, or runtime environments may allow attackers to execute malicious processes. Malicious processes, such as malware infections, can compromise the integrity of a containerized software application and cause a security event. Additionally, operational failures, including insufficient monitoring, lack of timely updates, or improper incident response procedures, can exacerbate security risks associated with malicious processes and increase the likelihood of successful attacks.

System 100 provides a comprehensive approach to determining root causes of security events associated with a containerized software applications. As described above, containerized software applications have become important in modern software development, offering flexibility and scalability. However, mitigating security events associated with containerized software applications can be complex. One of the greatest challenges in mitigating security events in containerized software applications is identifying the root cause of the security event. In order to provide an effective mitigation, security personnel need to understand the pathway, method, or mechanism by which an attacker or unauthorized entity gained access to the containerized software application.

Containers with containerized software applications can be deployed and managed in various ways. The main methods include direct deployment to a host, deployment and management via an orchestration application programming interface (API), and deployment through continuous integration/continuous deployment (CI/CD) pipelines. Accordingly, with containerized software applications, there are many potential levels for an attack-including the container level, the orchestration level, the cloud level, or the runtime level, as several possible examples. Attackers can infiltrate containerized software applications using various techniques, including directly accessing a running application (e.g. by exploiting a vulnerability), by abusing the orchestration API, by manipulating CI\CD pipelines, by changing deployment artifacts and configuration files, etc.

Advantageously, system 100 provides a solution for determining the root causes for security events associated with containerized software applications. System 100 correlates data from multiple levels associated with the containerized software application's computing environment to facilitate effective mitigation of an attack. System 100 is configured to determine possible malicious interactions with a containerized software application at several steps along the application's lifecycle—i.e., at one or more of the levels, including the container image level, the orchestration API level, the cloud administration level, and the container runtime level.

Systems configured to protect containerized software applications exist. Conventional systems often address isolated aspects of protection, such as by using image scanning tools (e.g., used to scan the image of a container before deployment), digital signature verification, or app-specific privileges (e.g., role based access control), runtime protections such as behavior based anomaly detection, etc. Conversely, system 100 integrates multiple data sources and provides a holistic root cause determination based on possible malicious processes with a containerized software application at the container image level, the cloud administration level, the orchestration API level, and the container runtime level.

In these and other ways, system 100 provides technical solutions to technical problems related to determining root causes of security events associated with containerized software applications, and mitigating such security events. System 100 provides a new structure (e.g., detecting malicious processes at multiple levels associated with the containerized software application) that provides secure containerized software applications. For example, in a conventional approach, some systems simply scan the image of a container before deployment (e.g., a container level security focus). These systems are not capable of security event root cause determination if the security even occurs at some other level—e.g., the orchestration API level, the cloud administration level, or the container runtime level. Worse, these systems may conclude that the root cause occurred at the wrong level (e.g., misconstruing a container image issue as an orchestration level malicious process because that particular conventional approach only focused on orchestration level problems).

More details related to the technical solution(s) provided by system 100 are described below, after introducing the components of system 100 and describing their operation. It should be noted, however, that not all embodiments necessarily provide all of the benefits outlined herein, and some embodiments provide all or a subset of these benefits or different benefits, as various engineering and cost tradeoffs are envisioned, which is not to imply that other descriptions are limiting.

System 100 includes computing engine 112, which may interact with mobile user devices 134 and 136, a desktop user device 138, external resources 146, or other systems. Interaction with users or other entities such as a company server (which may be represented by any of the computing devices shown in FIG. 1A, included in external resources, etc.) occurs via a website or a native application viewed on a desktop user device 138, a mobile user device 134 or 136, or other components. In some embodiments, interaction occurs via a desktop user device 138 such as a desktop computer, a mobile website viewed on a smart phone, tablet, or other mobile user device 134 or 136, or via a special-purpose native application executing on a smart phone, tablet, or other mobile user device. Determining a root cause of a security event associated with a containerized software application across a variety of devices is expected to make it easier for users to request or receive desired information when and where convenient for the user, or have other advantageous effects.

In some embodiments, computing engine 112 includes one or more of a processor 114, an application program interface (API) server 126, a web server 128, a memory 130, and a cache server 132. These components, in some embodiments, communicate with one another in order to provide the functionality of computing engine 112 described herein.

To illustrate an example of the environment in which computing engine 112 operates, FIG. 1A includes a number of components with which computing engine 112 communicates: mobile user devices 134 and 136; a desktop user device 138; and external resources 146. These devices communicate with computing engine 112 via a network 150, such as the Internet or the Internet in combination with various other networks, like local area networks, cellular networks, Wi-Fi networks, or personal area networks.

Mobile user devices 134 and 136 comprise smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to these components. The memory of mobile user devices 134 and 136 stores instructions that when executed by the associated processor provide an operating system and various applications, including a web browser 142, a native mobile application 140, or both. The desktop user device 138 also includes a web browser 144, a native application 145, or other electronic resources. In addition, desktop user device 138 includes a monitor; a keyboard; a mouse; memory; a processor; and a tangible, non-transitory, machine-readable memory storing instructions that when executed by the processor provide an operating system and the web browser 144 or the native application 145.

Native applications 140 and 145, and web browsers 142 and 144, in some embodiments, are operative to provide a graphical user interface associated with a user, for example, which communicates with computing engine 112 and facilitates user interaction with data from computing engine 112. In some embodiments, computing engine 112 is stored on or otherwise executed by user computing resources (e.g., a user computer, server, etc., such as mobile user devices 134 and 136, and desktop user device 138 associated with a user), servers external to the user, or in other locations. In some embodiments, computing engine 112 is run as an application (e.g., an app such as native application 140) on a server, a user computer, or other devices.

External resources 146 include sources of information such as databases, websites, etc.; external entities participating with system 100; one or more servers outside of system 100; a network (e.g., the internet); electronic storage; equipment related to Wi-Fi™ technology; equipment related to Bluetooth® technology; data entry devices; or other resources. External resources 146 include data sources 148. Data sources 148 may include information related to security events and/or other information. For example (and as described herein), information related to a security event may include a security alert. The security alert may comprise an automated notification generated in response to a detected security threat associated with a containerized software application (e.g., running on mobile user devices 134 and 136, desktop user device 138, etc.).

Data sources 148 are those available to system 100 for receiving or analyzing security events, determining the root cause(s) of security events, or otherwise using to function as described. Data sources 148 may comprise a large and varying set of data sources, with many different types of data, access protocols, etc. In some embodiments, data sources 148 comprise tabular data, graph data, data tables, columns of data, documents, charts, images, video, sensor data, or other data. Even though only a small number of data sources 148 are shown in FIG. 1A, these are intended to represent tens, hundreds, thousands, millions, or billions of different available data sources 148. In some embodiments, some or all of the different available data sources 148 are co-located (e.g., in a database server associated with a user), or individual available data sources 148 are located remotely from other data sources 148 (e.g., in different database servers associated with an organization and located across the world).

In some embodiments, some or all of the functionality attributed to external resources 146 is provided by resources included in system 100. External resources 146 are configured to communicate with computing engine 112, mobile user devices 134 and 136, desktop user device 138, or other components of system 100 via wired or wireless connections, via network 150 (e.g., a local area network or the internet), via cellular technology, via Wi-Fi technology, or via other resources.

Thus, computing engine 112, in some embodiments, operates in the illustrated environment by communicating with a number of different devices and transmitting instructions to various devices to communicate with one another. The number of illustrated external resources 146, desktop user devices 138, and mobile user devices 136 and 134 is selected for explanatory purposes only, and embodiments are not limited to the specific number of such devices illustrated by FIG. 1A, which is not to imply that other descriptions are limiting.

Memory 130 stores instructions 160 that, when executed by processor 114, cause processor 114 to execute the various operations described herein. In some embodiments, memory 130 stores or is configured to access other data (e.g., data in one or more data sources 148 described above) required for determining a root cause of a security event associated with a containerized software application, or other information that otherwise allows system 100 to function as described herein. In some embodiments, memory 130 includes various types of data stores, including relational or non-relational databases; image, document, etc., collections; or programming instructions for example. In some embodiments, such components are formed in a single database, or are stored in separate data structures. In some embodiments, memory 130 comprises electronic storage media that electronically stores information. In some embodiments, the electronic storage media of memory 130 includes one or both of system storage that is provided integrally (i.e., substantially non-removable) with system 100 or other storage that is connectable (wirelessly or via a wired connection) to system 100 via, for example, a port, a drive, a network (e.g., the Internet), etc. In some embodiments, memory 130 is (in whole or in part) a separate component within system 100, or memory 130 is provided (in whole or in part) integrally with one or more other components of system 100 (e.g., processor 114). In some embodiments, memory 130 is located in a data center, in a server that is part of external resources 146, in a computing device 134, 136, or 138, or in other locations. In some embodiments, memory 130 includes one or more of optically readable storage media, magnetically readable storage media, electrical charge-based storage media (e.g., EPROM, RAM, etc.), solid-state storage media, or other electronically readable storage media. In some embodiments, memory 130 stores software algorithms, information determined by processor 114, information received via a graphical user interface displayed on computing devices 134, 136, or 138, information received from external resources 146 (e.g., data from a search of a data source 148), or other information accessed by system 100 to function as described herein.

Processor 114 is configured to coordinate the operation of the other components of computing engine 112 to provide the functionality described herein. In some embodiments, processor 114 is formed by two or more processors, for example. As shown in FIG. 1A, in some embodiments, instructions 160 comprise a security event module 116, a root cause module 118, and an output module 120. Processor 114 is configured to direct the operation of modules 116, 118, or 120 by software; hardware; firmware; some combination of software, hardware, or firmware; machine-readable instructions; or other mechanisms for configuring processing capabilities.

Security event module 116 is configured to receive and analyze a security event to detect an instance of a malicious process. As described above, the security event may comprise a security alert or other security events. The security alert may comprise an automated notification generated in response to a detected security threat associated with a containerized software application, for example. In general, security events may comprise text, numerical or other indicators, timing information, or other information. Receiving the security event comprises electronically obtaining an electronic file describing the security event. The electronic file may be uploaded or downloaded, electronically communicated, electronically transferred, or otherwise provided to security event module 116 automatically or by a user (e.g., via one or more electronic commands provided via a computing device shown in FIG. 1A). In some embodiments, receiving the security event comprises obtaining or evaluating on-screen notifications (e.g., system pop-ups, application warnings), obtaining log files, receiving email or SMS alerts, receiving webhook or API notifications for automated security responses, etc. Analyzing the security event may include parsing text, determining patterns or aggregating data from log files, identifying event timing, etc.

Root cause module 118 is configured to determine the root causes of security events associated with containerized software applications. Root cause determination may include one or more of the following operations. Root cause determination may include one or more of the following operations because root cause module 118 is configured to cease root cause determination operations after the first operation in which it is successful identifying the root cause. For example, in some embodiments, root cause module 118 may comprise a programmed software function with a return statement. The return statement terminates execution of these operations, defines the output (see below), and facilitates retrieval of determined results, among other possible functions.

For a given security event, root cause module 118 is configured to determine whether an instance of a malicious process is present in an image of a container running the containerized software application. As described above, the instance of the malicious process comprises a program or code configured to perform unauthorized, harmful, or deceptive actions associated with a containerized software application. The instance of the malicious process may also or instead include ancestors of the malicious process. Ancestors comprise parent or originating processes that are responsible for spawning or executing a malicious process within a system.

Root cause module 118 is configured to determine whether the instance of the malicious process is present in the image of the container by extracting the details of the image of the running container. The image of the container comprises a static electronic file comprising elements needed to run the containerized application. A static electronic file refers to a digitally stored data file that remains unchanged once created and included within the container image. Unlike dynamic files that may be modified, updated, or generated at runtime, a static electronic file is preconfigured and embedded within the container image during the build process. Because the container image does not change once generated, the static electronic files within it ensure consistent execution across different deployments, enhancing reproducibility, security, and reliability in containerized environments. The container image comprises the code, dependencies, libraries, and runtime required to run the containerized software application.

Phrased another way, a container image is a lightweight, standalone, and non-editable electronic file that includes components for running a containerized application. It provides a base for creating containers, ensuring consistency across different environments. The image is built using a layered structure, where each layer represents a modification or addition to the base layer. When executed, the image is instantiated into a running container, which operates in an isolated environment while maintaining the integrity of the original image. A running container is a live instance of the container image that is actively executing the containerized software application. Examples of container images include an Alpine Linux-based container image, a Python application container image, or other container images.

Root cause module 118 is configured to identify the entry points and the arguments in the image layers. Image layers are stacked, read-only files that make up a container image (e.g., a base layer, dependency layers, an application code layer, a configuration layer, a read/write layer, etc.). Each image layer represents a modification to the underlying image and contributes to the final containerized environment. Entry points and arguments can be identified by inspecting an image layer, for example, using a ‘docker history’ command. If the malicious process or one of its ancestors appear in the entry point or arguments, root cause module 118 determines that the root cause of the security event is the image entry point, or more generally, the image of the container running the containerized software application is the root cause. Phrases another way, determining whether the instance of the malicious process is present in the image of the container running the containerized software application comprises analyzing image layers of the image of the container to identify entry points and arguments in the image layers, and determining whether the instance of the malicious process appears in an entry point or in the arguments in the image layers. If so, root cause module 118 determines the root cause is associated with the image of the container.

Root cause module 118 is configured to determine whether the instance of the malicious process is present in an orchestration object configured to run the container. An orchestration object is a structured entity used by a container orchestration system (such as Kubernetes) to define, manage, and automate the deployment, scaling, networking, and lifecycle of containerized applications. These objects act as instructions that describe how containers should be deployed, how they interact with each other, and how they are maintained. In some embodiments, determining whether the instance of the malicious process is present in an orchestration object configured to run the container comprises determining a configuration of the orchestration object, identifying an entry point and arguments in the configuration of the orchestration object, and determining whether the instance of the malicious process appears in the entry point or in the arguments of the orchestration object. If so, root cause module 118 determines that the root cause is associated with the orchestration object.

In some embodiments, determining the configuration of the orchestration object comprises querying an orchestration application program interface (API) to retrieve the configuration of the orchestration object. For example, the orchestration object may be a pod, or other orchestration objects. The pod comprises a logical host for one or more containerized applications. The pod may include one or more containers, along with shared networking and storage resources for the one or more containers, for example.

A pod can run a single container (most common) or multiple containers that work together (e.g., a web server+a logging sidecar container). Containers inside a pod share the same IP address and network namespace, such that they can communicate via localhost. A pod can define volumes that multiple containers within the pod can use for persistent storage. Pods are temporary and replaceable, and can be restarted or relocated as needed. As such, root cause module 118 can identify which pod runs a container that appears in a security alert. By querying the orchestration API, root cause module 118 can retrieve the pod configuration, and identify the entry point and the arguments in the pod configuration. If the malicious process or one of its ancestors appears in the entry point or arguments, root cause module 118 can determine that the root cause of the security event is the pod configuration. Root cause module 118 can also trace back which user deployed the pod with the malicious entry point.

Root cause module 118 is configured to determine whether the instance of the malicious process was initiated by a code execution command associated with the orchestration object. In some embodiments, the code execution command comprises an exec command configured to facilitate a user run command on the container. Determining whether the instance of the malicious process was initiated by the code execution command associated with the orchestration object comprises searching an orchestration API log for a period of time prior to the security event for the exec command. Responsive to the exec command being found in the orchestration API log, root cause module 118 determines the root cause is associated with the code execution command. In some embodiments, determining whether the instance of the malicious process was initiated by the code execution command associated with the orchestration object comprises determining which user executed the exec command based on the exec command found in the orchestration API log.

For example, root cause module 118 may be configured to trace back the orchestration API logs for one hour (e.g., as one possible example-other time periods are contemplated) prior to a security event trigger time. Root cause module 118 may search for exec commands which allow users to run commands on a target container (e.g., the container with the containerized software application). If found, root cause module 118 may determine whether the commands ran the malicious process or one of its ancestors. Root cause module 118 may also determine which user executed the exec command based on the information in the API logs or other information.

Root cause module 118 is configured to determine whether the instance of the malicious process was initiated by a cloud level command. A cloud-level command is an instruction executed within a cloud computing environment to manage, configure, or interact with cloud-based resources and services. In some embodiments, determining whether the instance of the malicious process was initiated by a cloud level command comprises searching a cloud provider API log for a period of time prior to the security event for a cloud-native run command operation comprising the instance of the malicious process. Responsive to the cloud-native run command being found in the cloud provider API log, root cause module 118 determines the root cause is associated with the cloud level command. In some embodiments, determining whether the instance of the malicious process was initiated by a cloud level command comprises determining which cloud user executed the cloud-native run command operation based on the cloud level command found in the cloud provider API log.

For example, root cause module 118 may be configured to trace back cloud provider API logs for one hour (e.g., as one possible example—other time periods are contemplated) prior to a security event trigger time. Root cause module 118 may be configured to search for cloud-native run command operations (e.g., using an AKS RunCommand in Azure). If found, root cause module 118 may determine whether the commands ran the malicious process or one of its ancestors, and which cloud user executed the run command operation (e.g., based on the information in the API and cloud logs or other information).

Root cause module 118 is configured to determine whether the instance of the malicious process resulted from a runtime exploitation based on timing of the security event relative to a container start time or other information. A runtime exploitation exploits vulnerabilities or misconfigurations in a software system, application, or container while it is actively running. Attackers may leverage weaknesses such as insecure code execution, memory corruption, privilege escalation, or exposed APIs to gain unauthorized access, manipulate data, execute malicious code, or disrupt system operations, for example. The container start time is the time duration between issuing a command to start a container and the moment the container becomes fully operational and ready to execute its intended workload. This time may include image loading, a filesystem setup, establishing a container's isolated environment, launching one or more processes, or other operations. In some embodiments, determining whether the instance of the malicious process resulted from the runtime exploitation comprises determining a time difference between the timing of the security event and the container start time. Responsive to the time difference breaching a threshold, root cause module 118 determines that the root cause of the security event is a runtime exploitation. For example, root cause module 188 may be configured to determine whether a time difference between a security event trigger time and a containerized software application start time. Responsive to the difference being greater than one hour (e.g., as one possible time threshold example-other time periods are contemplated), root cause module 118 is configured to determine that the root cause of the security event is a runtime exploitation.

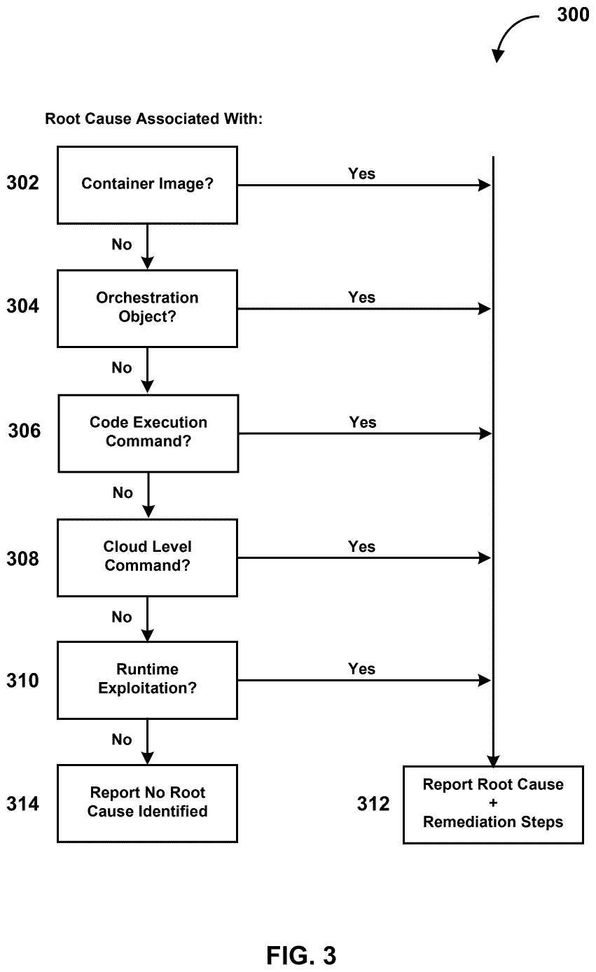

As described above, root cause module 118 is configured to determine the root causes of security events by successively advancing through one or more of the operations described above until a root cause is determined (e.g., also see FIG. 3 described below). If no root cause can be determined, root cause module 118 may be configured to cause an output (see output module 120 described below) indicating this lack of root cause identification. For example, root cause module 118 may simply output “N/A” or other similar indicator.

Root cause module 118 is also configured to facilitate execution of a security patch based on a root cause or other information. A security patch is configured to fix vulnerabilities, address security flaws, or mitigate potential threats in the containerized software application. A security patch may modify the containerized software application to add new security enhancement features, fix bugs, or otherwise enhance security related performance. A security patch may modifies or replace specific parts of the containerized software application's code. A security patch may be a software update, for example, or may take other forms. In some embodiments, a security patch comprises hardware modifications, configuration changes, network-based solutions, or security policies, among other possibilities. Facilitating execution of a security patch may include generating the security patch, identifying the security patch (e.g., by messaging or notifying a member of a software security team), testing the security patch, communicating (e.g., electronically) the security patch to an appropriate system for installation, installing the security patch, verifying and monitoring the security patch's effectiveness, or other activities.

Output module 120 is configured to output the root causes of security events (or an indication that no root cause could be determined). In some embodiments, outputting the root causes of security events comprises a portion of facilitating execution of a security patch (e.g., as described above related to root cause module 118). An output may indicate an origin of a malicious process, recommended mediation steps to mitigate a threat posed by the malicious process, recommended mediation steps to mitigate a future threat posed by the malicious process, or other information. In some embodiments, the output indicates whether a root cause is associated with a container image, a pod configuration, an exec command, a cloud run command, a runtime exploitation, or other root causes. In some embodiments, the output indicates a relevant user associated with the root cause, if such a user exists.

Output module 120 may be configured to output this information for display on one or more of the computing devices shown in FIG. 1A, or other computing devices. The outputting by output module 120 is configured to guide generation of security patches. Security patches may be generated automatically by system 100, manually by an information technology administrator, or in other ways.

The operations performed by modules 116-120 may be repeated (e.g., simultaneously or in succession) for tens, hundreds, thousands, or more containerized applications. For example.

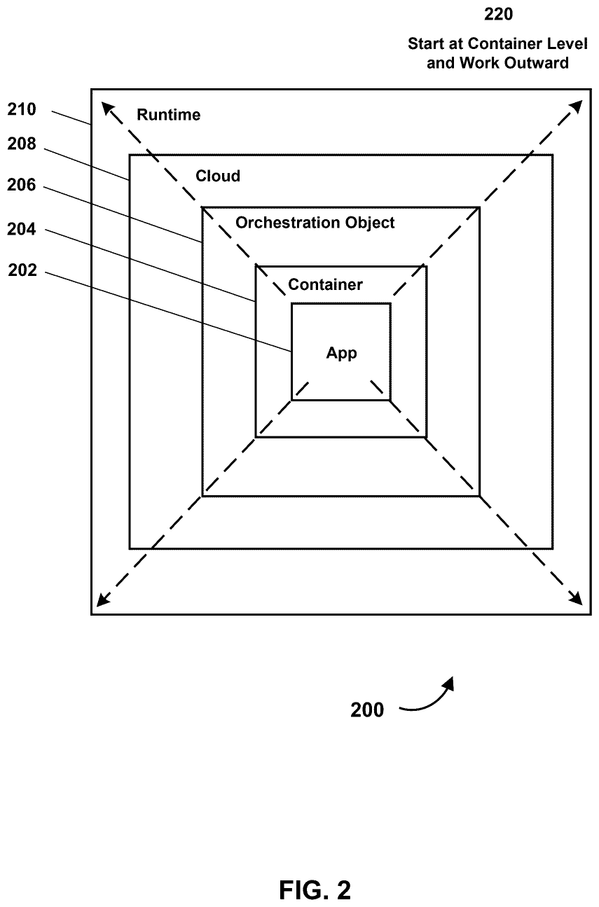

Additional details related to the operations performed by modules 116-120 are illustrated in FIG. 2 and FIG. 3, and described below.

For example, FIG. 2 illustrates several levels 200 in a containerized application computing environment. FIG. 2 illustrates a containerized software application or app 202, the container image level 204, the orchestration level 206, the cloud administration level 208, and the container runtime level 210. The root cause of a security event associated with a containerized software application is determined by successively advancing 220 through a series of operations (or steps), as described herein, starting at container image level 204 and continuing through container runtime level 210, until the root cause is identified. Phrased another way, the search for the root cause of security events is steadily broadened. The root cause determination operations start at the most granular level (container level) and progressively widen their scope. This technique is configured such that that the initial focus is on the container itself, but if no root cause is found, the search expands outward to broader components of the containerized software application computing environment. This may be though of as a bottom up analysis, an analysis that progressively expands in scope, or a layered root cause analysis, for example.

FIG. 3 illustrates an example flow 300 of operations performed by system 100 (FIG. 1A). As described above, and shown in FIG. 3, system 100 is configured for determining a root cause of a security event associated with a containerized software application. Flow 300 comprises determining whether a root cause of a security event is associated with a container image 302 (e.g., at container image level 204 shown in FIG. 2), an orchestration object 304 (e.g., at orchestration level 206 shown in FIG. 2), a code execution command 306 (e.g., at orchestration level 206), a cloud level command 308 (e.g., at cloud administration level 208 shown in FIG. 2), or a runtime exploitation 310 (e.g., at container runtime level 210 shown in FIG. 2). Flow 300 outputs a root cause determination 312 (along with remediation steps in some embodiments), or a report 314 that no root cause could be identified (e.g., the “N/A” output described above). This information may be used (e.g., by an information technology administrator, for example, or an automated system) to facilitate execution of a security patch based on the root cause, or to facilitate other operations.

Root cause determination in flow 300 may include one or more operations (e.g., one operation, two operations, three operations, four operations, or five operations) because root cause module 118 (FIG. 1A) is configured to cease root cause determination operations after the first operation in which it is successful identifying the root cause. For example, as shown in FIG. 3, responsive to the root cause being associated with container image 302 (i.e., “yes” in FIG. 3 at container image 302), root cause module 118 may terminate execution of other root cause determination operations (because there is no need for them), and define an output (report 314). However, if the root cause is not associated with container image 302 (i.e., “no” in FIG. 3 at container image 302), the root cause determination operations proceed to orchestration level determinations (associated with orchestration object 304 and code execution command 306), and so on, following the appropriate “yes” or “no” arrow as individual determinations are made for cloud level command 308 and runtime exploitation 310.

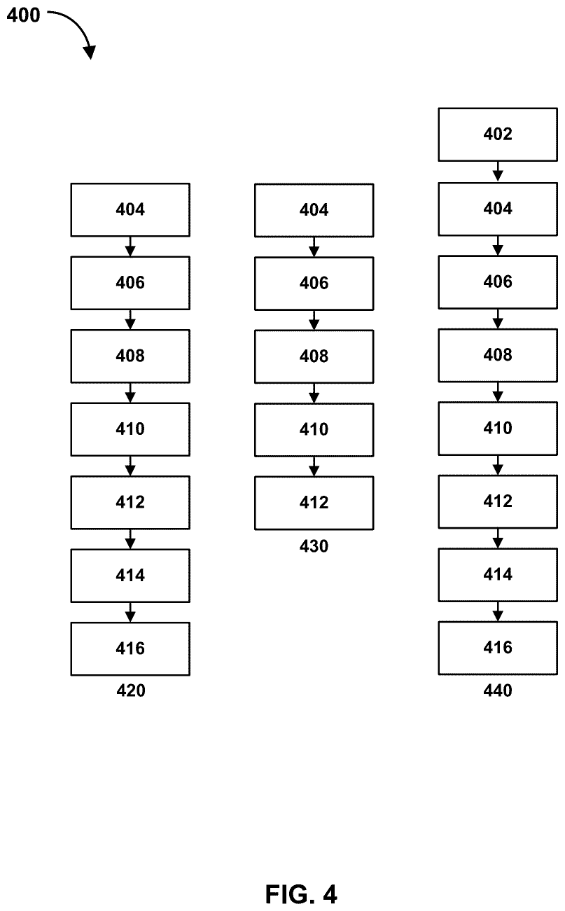

FIG. 4 illustrates different example embodiments 420, 430, and 440 of a method 400 for determining a root cause of a security event associated with a containerized software application. Embodiments 420, 430, and 440 of method 400 are performed with system 100 (FIG. 1A-FIG. 1D) or other components discussed above. Embodiments 420, 430, or 440 may correspond to one or more of the pathways (following various “yes” and “no” arrows) through flow 300 shown in FIG. 3, for example.

Embodiment 420 of method 400 begins with operation 404, comprising determining whether an instance of a malicious process is present in an image of a container running the containerized software application. Embodiment 420 continues with operation 406, comprising determining whether the instance of the malicious process is present in an orchestration object configured to run the container. Operation 408 comprises determining whether the instance of the malicious process was initiated by a code execution command associated with the orchestration object. Operation 410 comprises determining whether the instance of the malicious process was initiated by a cloud level command. Operation 412 comprises determining whether the instance of the malicious process resulted from a runtime exploitation based on timing of the security event relative to a container start time. Operation 414 comprises determining the root cause of the security event associated with the containerized software application by successively advancing through one or more of operations 404-412; and operation 416 comprises facilitating execution of a security patch based on the root cause (e.g., with all of these operations performed as described above). Embodiment 420 of method 400 stops after the first operation in which method 400 successfully identifies the root cause (e.g., if embodiment 420 was a programming function, there may be a “return” statement in each operation 404-412—see FIG. 3).

Embodiment 430 of method 400 comprises successively advancing through one or more operations (e.g., steps) in a series of operations (steps) until the root cause is identified. In embodiment 430, the operations include operation 404, again comprising determining whether an instance of a malicious process is present in an image of a container running the containerized software application. Embodiment 430 includes operation 406, comprising determining whether the instance of the malicious process is present in an orchestration object configured to run the container. Embodiment 430 also includes operation 408 (determining whether the instance of the malicious process was initiated by a code execution command associated with the orchestration object), operation 410 (determining whether the instance of the malicious process was initiated by a cloud level command), and operation 412 (determining whether the instance of the malicious process resulted from a runtime exploitation based on timing of the security event relative to a container start time), all as described above.

Embodiment 440 of method 400 begins with operation 402, comprising receiving and analyzing a security alert (i.e., an example of a security event) to detect an instance of a malicious process. The security alert comprises an automated notification generated in response to a detected security threat associated with the containerized software application. Embodiment 440 continues with operation 404 (determining whether the instance of the malicious process is present in an image of a container running the containerized software application), operation 406 (determining whether the instance of the malicious process is present in an orchestration object configured to run the container), operation 408 (determining whether the instance of the malicious process was initiated by a code execution command associated with the orchestration object), operation 410 (determining whether the instance of the malicious process was initiated by a cloud level command), operation 412 (determining whether the instance of the malicious process resulted from a runtime exploitation based on timing of the security event relative to a container start time), operation 414 (determining the root cause of the security alert), and operation 416 (facilitating execution of a security patch based on the root cause). Embodiment 440 starts at operation 402, and successively advances through one or more of operations 404-412 until the root cause is determined.

Embodiments 420, 430, and 440 of method 400 may include additional operations that are not described, or do not include one or more of the operations described below. The operations of embodiments 420, 430, and 440 of method 400 may be performed in any order that facilitates determining a root cause of a security event associated with a containerized software application, as described herein. Even though these are shown as separate embodiments, operations from one embodiment may be combined with another. In addition, embodiments 420, 430, and 440 are not the only three possible embodiments of method 400. Other variations are contemplated.

Returning to FIG. 1A, system 100 can have many different forms, with or without some or all of the components shown in FIG. 1A, and still be configured to function as described. For example, FIG. 1B, FIG. 1C, and FIG. 1D illustrate examples of alternative potential embodiments of system 100. FIG. 1B illustrates system 100 without API server 126, web server 128, cache server 132, mobile user devices 134 and 136, or desktop user device 138 (e.g., which in this example are their own standalone devices, apart from system 100). FIG. 1C illustrates system 100 with processor 114, instructions 160 (including the different modules 116-120), memory 130 (which may or may not be included in the same computing structure as processor 114), and data sources 148. In this example, the data sources are their own separate entities, not necessarily being related to each other. FIG. 1D illustrates system 100 with processor 114, instructions 160 (without being separately divided into the different modules 116-120), memory 130 (which again may or may not be included in the same computing structure as processor 114), and data sources 148. Other embodiments with different arrangements of components are contemplated.

In FIG. 1A-1D, the different components of system 100 are illustrated communicating via network 150. This is not intended to be limiting. As described herein, different components of system 100 communicate via network 150 (as shown), via wired connections, or via other wired or wireless connections. The illustrated components communicate directly with each other (e.g., via network 150 or a wired connection), or indirectly via other components of system 100.

It should be noted that in some embodiments, computing engine 112 is configured such that in the above mentioned operations of processor 114, and input from users or sources of information inside or outside system 100, are processed by processor 114 through a variety of formats, including clicks, touches, uploads, downloads, etc. The illustrated components (e.g., processor 114, API server 126, web server 128, memory 130, and cache server 132) of computing engine 112 are depicted as discrete functional blocks, but embodiments are not limited to systems in which the functionality described herein is organized as illustrated by FIG. 1A. In some embodiments, the functionality provided by the components of computing engine 112 is provided by software or hardware modules that are differently organized than is presently depicted, for example such software or hardware is intermingled, broken up, distributed (e.g., within a data center or geographically), or otherwise differently organized. In some embodiments, the functionality described is provided by one or more processors of one or more computers executing code stored on a tangible, non-transitory, machine readable medium.

It should be appreciated that although modules 116-120 are illustrated in FIG. 1A (and 1B and 1C) as being co-located, one or more of modules 116, 118, or 120 may be located remotely from the other modules. The description of the functionality provided by the different modules 116, 118, or 120 described herein is for illustrative purposes, and is not intended to be limiting, as any of the modules 116, 118, or 120 may provide more or less functionality than is described, which is not to imply that other descriptions are limiting. For example, one or more of modules 116, 118, or 120 may be eliminated, and some or all of its functionality may be provided by others of the modules 116, 118, or 120, again which is not to imply that other descriptions are limiting. As another example, processor 114 may be configured to control one or more additional modules that perform some or all of the functionality attributed to one of the modules 116, 118, or 120.

Modules 116-120 are program instructions that are executable by a processor 114 to implement one or more embodiments of the present techniques. In some embodiments, program instructions include a computer program (which in certain forms is known as a program, software, software application, script, or code). A computer program is written in a programming language, including compiled or interpreted languages, or declarative or procedural languages. In some embodiments, a computer program includes a unit suitable for use in a computing environment, including as a stand-alone program, a module, a component, or a subroutine. In some embodiments, a computer program corresponds to a file in a file system. A program is stored in a portion of a file that holds other programs or data (e.g., one or more scripts stored in a markup language document), in a single file dedicated to the program in question, or in multiple coordinated files (e.g., files that store one or more modules, sub programs, or portions of code). In some embodiments, a computer program is deployed to be executed on one or more computer processors located locally at one site or distributed across multiple remote sites and interconnected by a communication network, for example.

Cache server 132 expedites access to relevant data by storing likely relevant data in relatively high-speed memory, for example, in random-access memory or a solid-state drive (e.g., formed by at least a portion of memory 130). Web server 128 serves webpages having graphical user interfaces that display one or more views that facilitate receiving entry or selection of input from a user (e.g., including a query or command that system 100 perform a certain task, providing context, etc.), or other views. API server 126 serves data to various applications that process data related to user requested tasks, or other data. The operation of these components (API server 126, web server 128, and memory 130) is coordinated by processor 114, which bidirectionally communicates with these components or directs the components to communicate with one another. Communication occurs by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

API server 126 is configured to communicate user text commands or other information via a protocol, such as a representational-state-transfer (REST)-based API protocol over hypertext transfer protocol (HTTP) or other protocols. API requests identify which output data is to be determined, displayed, linked, modified, added, or retrieved by specifying criteria for identifying tasks, such as queries for retrieving or processing information about a particular subject (e.g., an optimal list of groups for a certain electronic application). In some embodiments, API server 126 communicates with native application 140 of the mobile user device 134, native application 145 of desktop user device 138, or other components of system 100.

Web server 128 is configured to display, link, modify, add, or retrieve portions or all of an output, or other information encoded in a webpage (e.g., a collection of resources to be rendered by the browser and associated plug-ins, including execution of scripts, such as JavaScript™, invoked by the webpage). In some embodiments, the graphical user interface presented by the webpage includes inputs by which the user enters or selects data, such as clickable or touchable display regions or display regions for text input. Such inputs prompt the browser to request additional data from web server 128 or transmit data to web server 128, and web server 128 responds to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g., JavaScript™ object notation (JSON) or extensible markup language (XML). Web server 128 communicates with web browsers, such as web browser 142 or 144 executed by user devices 136 or 138. In some embodiments, the webpage is modified by web server 128 based on the type of user device, e.g., with a mobile webpage having fewer and smaller images and a narrower width being presented to the mobile user device 136, and a larger, more content rich webpage being presented to the desktop user device 138. In some embodiments, an identifier of the type of user device, either mobile or non-mobile, for example, is encoded in the request for the webpage by the web browser (e.g., as a user agent type in an HTTP header associated with a GET request), and web server 128 selects the appropriate interface based on this embedded identifier, thereby providing an interface appropriately configured for the specific user device in use.

Web browsers 142 and 144 are configured to receive a website from computing engine 112 having data related to instructions (for example, instructions expressed in JavaScript™) that when executed by the browser (which is executed by the processor) cause mobile user devices 134 or 136, or desktop user device 138, to communicate with computing engine 112 and facilitate user interaction with data from computing engine 112. Native applications 140 and 145, and web browsers 142 and 144, upon rendering a webpage or a graphical user interface from computing engine 112, may generally be referred to as client applications of computing engine 112, which in some embodiments may be referred to as a server. Embodiments, however, are not limited to client/server architectures, and computing engine 112, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, or multiple countries across the world.

Though not illustrated in FIG. 1A (or 1B, 1C, or 1D), computing engine 112, in some embodiments, includes multiple processors 114, an input/output I/O device interface, and a network interface via an input/output (I/O) interface. In some embodiments, multiple processors are employed to provide for parallel or sequential execution of one or more portions of the techniques described herein. The I/O device interface provides an interface for connection of one or more I/O devices to computing engine 112. I/O devices include devices that receive input (e.g., from a user) or output information (e.g., to a user). I/O devices include, for example, graphical user interfaces presented on displays (e.g., a touchscreen or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices are connected to computing engine through a wired or wireless connection. I/O devices are connected to computing engine 112 from a remote location. I/O devices located on a remote computer system, for example, are connected to computing engine 112 via network 150 and the network interface.

The network interface includes a network adapter that provides for connection of computing engine 112 to network 150. The network interface facilitates data exchange between computing engine 112 and other devices connected to network 150. The network interface supports wired or wireless communication. In some embodiments, network 150 includes an electronic communication network, such as the Internet, a local area network (LAN), a wide area network (WAN), a cellular communications network, and the like.

The I/O interface is configured to coordinate I/O traffic between processors, memory 130, the network interface, I/O devices, or other peripheral devices. The I/O interface performs protocol, timing, or other data transformations to convert data signals from one component (e.g., memory 130) into a format suitable for use by another component (e.g., processor(s) 114). In some embodiments, the I/O interface includes support for devices attached through various types of peripheral buses, such as a variant of the Peripheral Component Interconnect (PCI) bus standard or the Universal Serial Bus (USB or USB-C) standard.

Embodiments of the techniques described herein may be implemented using a single instance of computing engine 112 or multiple computer systems configured to host different portions or instances of embodiments. Multiple computer systems may provide for parallel or sequential processing/execution of one or more portions of the techniques described herein.

While various items are illustrated or described as being stored in memory, these items or portions of them may be transferred between memory and other storage devices for purposes of memory management and data integrity. Alternatively, in other embodiments some or all of the software components execute in memory on another device and communicate with the illustrated computer system via inter-computer communication. In some embodiments, some or all of the system components or data structures are stored (e.g., as instructions or structured data) on a computer-accessible medium or a portable article to be read by an appropriate drive, various examples of which are described above. In some embodiments, instructions stored on a computer-accessible medium separate from computing engine 112 are transmitted to computing engine 112 via transmission media or signals such as electrical, electromagnetic, or digital signals, conveyed via a communication medium such as a network or a wireless link. Various embodiments include receiving, sending, or storing instructions or data implemented in accordance with the foregoing description upon a computer-accessible medium. Accordingly, the present techniques may be practiced with other computer system configurations.

To mitigate the problems described herein, the inventors had to both invent solutions and, in some cases just as importantly, recognize problems overlooked (or not yet foreseen) by others for limiting access privileges to provide secure group-based access to an electronic application. The inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described.

In block diagrams, illustrated components are depicted as discrete functional blocks, but embodiments are not limited to systems in which the functionality described herein is organized as illustrated. The functionality provided by the components may be provided by software or hardware modules that are differently organized than is presently depicted, for example such software or hardware may be intermingled, conjoined, replicated, broken up, distributed (e.g., within a data center or geographically), or otherwise differently organized. The functionality described may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with individual computing devices having different subsets of the instructions, an implementation consistent with usage of the singular term “medium.” In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several embodiments. Rather than separating those embodiments into multiple isolated patent applications, applicants have grouped these embodiments into a single document because their related subject matter lends itself to economies in the application process. But the distinct advantages and aspects of these embodiments should not be conflated. In some cases, embodiments address all of the deficiencies noted herein, but it should be understood that the embodiments are independently useful, and some embodiments address only a subset of such problems or offer other, unmentioned benefits that will be apparent to those of skill in the art reviewing the present disclosure. Due to cost constraints, some disclosed embodiments are not presently claimed and may be claimed in later filings, such as continuation applications or by amending the present claims. Similarly, due to space constraints, neither the Abstract nor the Summary sections of the present document should be taken as containing a comprehensive listing of all such embodiments or all aspects of such embodiments.

It should be understood that the description and the drawings are not intended to limit an embodiment to the particular form disclosed, but to the contrary, the intention is to cover all modifications, equivalents, and alternatives falling within the spirit and scope of the present embodiments as defined by the appended claims. Further modifications and alternative embodiments will be apparent to those skilled in the art in view of this description. Accordingly, this description and the drawings are to be construed as illustrative only and are for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features may be utilized independently, all as would be apparent to one skilled in the art after having the benefit of this description. Changes may be made in the elements described without departing from the spirit and scope of the embodiments as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., all processors performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in a category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A method for determining a root cause of a security event associated with a containerized software application, the method comprising: (a) determining whether an instance of a malicious process is present in an image of a container running the containerized software application; (b) determining whether the instance of the malicious process is present in an orchestration object configured to run the container; (c) determining whether the instance of the malicious process was initiated by a code execution command associated with the orchestration object; (d) determining whether the instance of the malicious process was initiated by a cloud level command; (e) determining whether the instance of the malicious process resulted from a runtime exploitation based on timing of the security event relative to a container start time; determining the root cause of the security event associated with the containerized software application by successively advancing through one or more of (a)-(e); and facilitating execution of a security patch based on the root cause.
2. The method of embodiment 1, wherein the security event is a security alert, the security alert comprising an automated notification generated in response to a detected security threat associated with the containerized software application.
3. The method of any of the previous embodiments, further comprising receiving and analyzing the security alert to detect the instance of the malicious process.
4. The method of any of the previous embodiments, wherein the containerized software application comprises software code that runs inside the container.
5. The method of any of the previous embodiments, wherein the container comprises an isolated environment configured to ensure the software code runs consistently across different computing systems; wherein the different computing systems comprise one or more of a local desktop, laptop, or tablet computer; a virtual machine; a data center; a cloud computing system; or an edge computing system.
6. The method of any of the previous embodiments, wherein the instance of the malicious process includes ancestors of the malicious process.
7. The method of any of the previous embodiments, wherein the image of the container comprises a static electronic file comprising elements needed to run the containerized application, including code, dependencies, libraries, and runtime.
8. The method of any of the previous embodiments, wherein determining whether the instance of the malicious process is present in the image of the container running the containerized software application comprises analyzing layers of the image of the container to identify entry points and arguments in the image layers, and determining whether the instance of the malicious process appears in an entry point or in the arguments in the image layers, and if so, determining the root cause is associated with the image of the container.
9. The method of any of the previous embodiments, wherein determining whether the instance of the malicious process is present in an orchestration object configured to run the container comprises determining a configuration of the orchestration object, identifying an entry point and arguments in the configuration of the orchestration object, and determining whether the instance of the malicious process appears in the entry point or in the arguments of the orchestration object, and if so, determining the root cause is associated with the orchestration object.
10. The method of any of the previous embodiments, wherein determining the configuration of the orchestration object comprises querying an orchestration application program interface (API) to retrieve the configuration of the orchestration object.
11. The method of any of the previous embodiments, wherein the orchestration object is a pod, the pod comprising a logical host for one or more containerized applications, the pod including one or more containers, along with shared networking and storage resources for the one or more containers.
12. The method of any of the previous embodiments, wherein the code execution command comprises an exec command configured to facilitate a user run command on the container, and determining whether the instance of the malicious process was initiated by the code execution command associated with the orchestration object comprises searching an orchestration API log for a period of time prior to the security event for the exec command, and responsive to the exec command being found in the orchestration API log, determining the root cause is associated with the code execution command.
13. The method of any of the previous embodiments, wherein determining whether the instance of the malicious process was initiated by the code execution command associated with the orchestration object further comprises determining which user executed the exec command based on the exec command found in the orchestration API log.
14. The method of any of the previous embodiments, wherein determining whether the instance of the malicious process was initiated by a cloud level command comprises searching a cloud provider API log for a period of time prior to the security event for a cloud-native run command operation comprising the instance of the malicious process, and responsive to the cloud-native run command being found in the cloud provider API log, determining the root cause is associated with the cloud level command.
15. The method of any of the previous embodiments, wherein determining whether the instance of the malicious process was initiated by a cloud level command further comprises determining which cloud user executed the cloud-native run command operation based on the cloud level command found in the cloud provider API log.
16. The method of any of the previous embodiments, wherein determining whether the instance of the malicious process resulted from the runtime exploitation comprises determining a time difference between the timing of the security event and the container start time, and, responsive to the time difference breaching a threshold, determining that the root cause of the security event is a runtime exploitation.
17. The method of any of the previous embodiments, wherein facilitating execution of the security patch based on the root cause comprises outputting the root cause of the security event, the outputting indicating one or more of (1) an origin of the malicious process, (2) recommended mediation steps to mitigate a threat posed by the malicious process, and (3) recommended mediation steps to mitigate a future threat posed by the malicious process.
18. A system for determining a root cause of a security event associated with a containerized software application by successively advancing through one or more steps in a series of steps until the root cause is identified, the system comprising: memory storing instructions; and one or more processors configured to execute the instructions and advance through the one or more steps in the series of steps, the series of steps comprising:: (a) determining whether an instance of a malicious process is present in an image of a container running the containerized software application; (b) determining whether the instance of the malicious process is present in an orchestration object configured to run the container; (c) determining whether the instance of the malicious process was initiated by a code execution command associated with the orchestration object; (d) determining whether the instance of the malicious process was initiated by a cloud level command; and (e) determining whether the instance of the malicious process resulted from a runtime exploitation based on timing of the security event relative to a container start time.
19. The system of embodiment 18, the series of steps further comprising executing a security patch based on the root cause.
20. The system of any of the previous embodiments, wherein the security event is a security alert, the security alert comprising an automated notification generated in response to a detected security threat associated with the containerized software application.
21. The system of any of the previous embodiments, further comprising receiving and analyzing the security alert to detect the instance of the malicious process.
22. The system of any of the previous embodiments, wherein the containerized software application comprises software code that runs inside the container.
23. The system of any of the previous embodiments, wherein the container comprises an isolated environment configured to ensure the software code runs consistently across different computing systems; wherein the different computing systems comprise one or more of a local desktop, laptop, or tablet computer; a virtual machine; a data center; a cloud computing system; or an edge computing system.
24. The system of any of the previous embodiments, wherein the instance of the malicious process includes ancestors of the malicious process.
25. The system of any of the previous embodiments, wherein the image of the container comprises a static electronic file comprising elements needed to run the containerized application, including code, dependencies, libraries, and runtime.
26. The system of any of the previous embodiments, wherein determining whether the instance of the malicious process is present in the image of the container running the containerized software application comprises analyzing layers of the image of the container to identify entry points and arguments in the image layers, and determining whether the instance of the malicious process appears in an entry point or in the arguments in the image layers, and if so, determining the root cause is associated with the image of the container.
27. The system of any of the previous embodiments, wherein determining whether the instance of the malicious process is present in an orchestration object configured to run the container comprises determining a configuration of the orchestration object, identifying an entry point and arguments in the configuration of the orchestration object, and determining whether the instance of the malicious process appears in the entry point or in the arguments of the orchestration object, and if so, determining the root cause is associated with the orchestration object.
28. The system of any of the previous embodiments, wherein determining the configuration of the orchestration object comprises querying an orchestration application program interface (API) to retrieve the configuration of the orchestration object.
29. The system of any of the previous embodiments, wherein the orchestration object is a pod, the pod comprising a logical host for one or more containerized applications, the pod including one or more containers, along with shared networking and storage resources for the one or more containers.
30. The system of any of the previous embodiments, wherein the code execution command comprises an exec command configured to facilitate a user run command on the container, and determining whether the instance of the malicious process was initiated by the code execution command associated with the orchestration object comprises searching an orchestration API log for a period of time prior to the security event for the exec command, and responsive to the exec command being found in the orchestration API log, determining the root cause is associated with the code execution command.
31. The system of any of the previous embodiments, wherein determining whether the instance of the malicious process was initiated by the code execution command associated with the orchestration object further comprises determining which user executed the exec command based on the exec command found in the orchestration API log.
32. The system of any of the previous embodiments, wherein determining whether the instance of the malicious process was initiated by a cloud level command comprises searching a cloud provider API log for a period of time prior to the security event for a cloud-native run command operation comprising the instance of the malicious process, and responsive to the cloud-native run command being found in the cloud provider API log, determining the root cause is associated with the cloud level command.
33. The system of any of the previous embodiments, wherein determining whether the instance of the malicious process was initiated by a cloud level command further comprises determining which cloud user executed the cloud-native run command operation based on the cloud level command found in the cloud provider API log.
34. The system of any of the previous embodiments, wherein determining whether the instance of the malicious process resulted from the runtime exploitation comprises determining a time difference between the timing of the security event and the container start time, and, responsive to the time difference breaching a threshold, determining that the root cause of the security event is a runtime exploitation.
35. The system of any of the previous embodiments, wherein facilitating execution of the security patch based on the root cause comprises outputting the root cause of the security event, the outputting indicating one or more of (1) an origin of the malicious process, (2) recommended mediation steps to mitigate a threat posed by the malicious process, and (3) recommended mediation steps to mitigate a future threat posed by the malicious process.
36. A system for determining a root cause of a security event associated with a containerized software application, the system comprising a processor and memory storing instructions that, when executed by the processor, cause the system to successively advance through one or more steps in a series of steps until the root cause is identified, the series of steps comprising: (a) determining whether an instance of a malicious process is present in an image of a container running the containerized software application; (b) determining whether the instance of the malicious process is present in an orchestration object configured to run the container; (c) determining whether the instance of the malicious process was initiated by a code execution command associated with the orchestration object; (d) determining whether the instance of the malicious process was initiated by a cloud level command; and (e) determining whether the instance of the malicious process resulted from a runtime exploitation based on timing of the security event relative to a container start time.
37. A non-transitory computer readable medium having instructions thereon, the instructions, when executed by a computer, causing the computer to perform operations for determining a root cause of a security alert associated with a containerized software application, the operations comprising: (a) receiving and analyzing the security alert to detect an instance of a malicious process, the security alert comprising an automated notification generated in response to a detected security threat associated with the containerized software application; (b) determining whether the instance of the malicious process is present in an image of a container running the containerized software application; (c) determining whether the instance of the malicious process is present in an orchestration object configured to run the container; (d) determining whether the instance of the malicious process was initiated by a code execution command associated with the orchestration object; (e) determining whether the instance of the malicious process was initiated by a cloud level command; (f) determining whether the instance of the malicious process resulted from a runtime exploitation based on timing of the security event relative to a container start time; determining the root cause of the security alert associated with the containerized software application by starting at (a) and successively advancing through one or more of (a)-(e) until the root cause is determined; and facilitating execution of a security patch based on the root cause.
38. The medium of embodiment 37, wherein the containerized software application comprises software code that runs inside the container.
39. The medium of any of the previous embodiments, wherein the container comprises an isolated environment configured to ensure the software code runs consistently across different computing systems; wherein the different computing systems comprise one or more of a local desktop, laptop, or tablet computer; a virtual machine; a data center; a cloud computing system; or an edge computing system.
40. The medium of any of the previous embodiments, wherein the instance of the malicious process includes ancestors of the malicious process.
41. The medium of any of the previous embodiments, wherein the image of the container comprises a static electronic file comprising elements needed to run the containerized application, including code, dependencies, libraries, and runtime.
42. The medium of any of the previous embodiments, wherein determining whether the instance of the malicious process is present in the image of the container running the containerized software application comprises analyzing layers of the image of the container to identify entry points and arguments in the image layers, and determining whether the instance of the malicious process appears in an entry point or in the arguments in the image layers, and if so, determining the root cause is associated with the image of the container.
43. The medium of any of the previous embodiments, wherein determining whether the instance of the malicious process is present in an orchestration object configured to run the container comprises determining a configuration of the orchestration object, identifying an entry point and arguments in the configuration of the orchestration object, and determining whether the instance of the malicious process appears in the entry point or in the arguments of the orchestration object, and if so, determining the root cause is associated with the orchestration object.
44. The medium of any of the previous embodiments, wherein determining the configuration of the orchestration object comprises querying an orchestration application program interface (API) to retrieve the configuration of the orchestration object.
45. The medium of any of the previous embodiments, wherein the orchestration object is a pod, the pod comprising a logical host for one or more containerized applications, the pod including one or more containers, along with shared networking and storage resources for the one or more containers.
46. The medium of any of the previous embodiments, wherein the code execution command comprises an exec command configured to facilitate a user run command on the container, and determining whether the instance of the malicious process was initiated by the code execution command associated with the orchestration object comprises searching an orchestration API log for a period of time prior to the security event for the exec command, and responsive to the exec command being found in the orchestration API log, determining the root cause is associated with the code execution command.
47. The medium of any of the previous embodiments, wherein determining whether the instance of the malicious process was initiated by the code execution command associated with the orchestration object further comprises determining which user executed the exec command based on the exec command found in the orchestration API log.
48. The medium of any of the previous embodiments, wherein determining whether the instance of the malicious process was initiated by a cloud level command comprises searching a cloud provider API log for a period of time prior to the security event for a cloud-native run command operation comprising the instance of the malicious process, and responsive to the cloud-native run command being found in the cloud provider API log, determining the root cause is associated with the cloud level command.
49. The medium of any of the previous embodiments, wherein determining whether the instance of the malicious process was initiated by a cloud level command further comprises determining which cloud user executed the cloud-native run command operation based on the cloud level command found in the cloud provider API log.
50. The medium of any of the previous embodiments, wherein determining whether the instance of the malicious process resulted from the runtime exploitation comprises determining a time difference between the timing of the security event and the container start time, and, responsive to the time difference breaching a threshold, determining that the root cause of the security event is a runtime exploitation.
51. The medium of any of the previous embodiments, wherein facilitating execution of the security patch based on the root cause comprises outputting the root cause of the security event, the outputting indicating one or more of (1) an origin of the malicious process, (2) recommended mediation steps to mitigate a threat posed by the malicious process, and (3) recommended mediation steps to mitigate a future threat posed by the malicious process.

1. A method for determining a root cause of a security event associated with a containerized software application, the method comprising:
(a) determining whether an instance of a malicious process is present in an image of a container running the containerized software application;
(b) determining whether the instance of the malicious process is present in an orchestration object configured to run the container;
(c) determining whether the instance of the malicious process was initiated by a code execution command associated with the orchestration object;
(d) determining whether the instance of the malicious process was initiated by a cloud level command;
(e) determining whether the instance of the malicious process resulted from a runtime exploitation based on timing of the security event relative to a container start time;
determining the root cause of the security event associated with the containerized software application by successively advancing through one or more of (a) (e); and
facilitating execution of a security patch based on the root cause.

2. The method of claim 1, wherein the security event is a security alert, the security alert comprising an automated notification generated in response to a detected security threat associated with the containerized software application.

3. The method of claim 2, further comprising:
receiving the security alert; and
analyzing the security alert to detect the instance of the malicious process.

4. The method of claim 1, wherein the containerized software application comprises software code that runs inside the container.

5. The method of claim 4, wherein the container comprises an isolated environment configured to ensure the software code runs consistently across different computing systems;
wherein the different computing systems comprise one or more of a local desktop, laptop, or tablet computer; a virtual machine; a data center; a cloud computing system; or an edge computing system.

6. The method of claim 1, wherein the instance of the malicious process includes ancestors of the malicious process.

7. The method of claim 1, wherein the image of the container comprises a static electronic file comprising elements needed to run the containerized application, including code, dependencies, libraries, and runtime.

8. The method of claim 7, wherein determining whether the instance of the malicious process is present in the image of the container running the containerized software application comprises analyzing image layers of the image of the container to identify entry points and arguments in the image layers, and determining whether the instance of the malicious process appears in an entry point or in the arguments in the image layers, and if so, determining the root cause is associated with the image of the container.

9. The method of claim 1, wherein determining whether the instance of the malicious process is present in an orchestration object configured to run the container comprises determining a configuration of the orchestration object, identifying an entry point and arguments in the configuration of the orchestration object, and determining whether the instance of the malicious process appears in the entry point or in the arguments of the orchestration object, and if so, determining the root cause is associated with the orchestration object.

10. The method of claim 9, wherein determining the configuration of the orchestration object comprises querying an orchestration application program interface (API) to retrieve the configuration of the orchestration object.

11. The method of claim 1, wherein the orchestration object is a pod, the pod comprising a logical host for one or more containerized applications, the pod including one or more containers, along with shared networking and storage resources for the one or more containers.

12. The method of claim 1, wherein the code execution command comprises an exec command configured to facilitate a user run command on the container, and determining whether the instance of the malicious process was initiated by the code execution command associated with the orchestration object comprises searching an orchestration API log for a period of time prior to the security event for the exec command, and responsive to the exec command being found in the orchestration API log, determining the root cause is associated with the code execution command.

13. The method of claim 12, wherein determining whether the instance of the malicious process was initiated by the code execution command associated with the orchestration object further comprises determining which user executed the exec command based on the exec command found in the orchestration API log.

14. The method of claim 1, wherein determining whether the instance of the malicious process was initiated by a cloud level command comprises searching a cloud provider API log for a period of time prior to the security event for a cloud-native run command operation comprising the instance of the malicious process, and responsive to the cloud-native run command being found in the cloud provider API log, determining the root cause is associated with the cloud level command.

15. The method of claim 14, wherein determining whether the instance of the malicious process was initiated by a cloud level command further comprises determining which cloud user executed the cloud-native run command operation based on the cloud level command found in the cloud provider API log.

16. The method of claim 1, wherein determining whether the instance of the malicious process resulted from the runtime exploitation comprises determining a time difference between the timing of the security event and the container start time, and, responsive to the time difference breaching a threshold, determining that the root cause of the security event is a runtime exploitation.

17. The method of claim 1, wherein facilitating execution of the security patch based on the root cause comprises outputting the root cause of the security event, the outputting indicating one or more of (1) an origin of the malicious process, (2) recommended mediation steps to mitigate a threat posed by the malicious process, and (3) recommended mediation steps to mitigate a future threat posed by the malicious process.

18. A system for determining a root cause of a security event associated with a containerized software application by successively advancing through one or more steps in a series of steps until the root cause is identified, the system comprising:
memory storing instructions; and
one or more processors configured to execute the instructions and advance through the one or more steps in the series of steps, the series of steps comprising:
(a) determining whether an instance of a malicious process is present in an image of a container running the containerized software application;
(b) determining whether the instance of the malicious process is present in an orchestration object configured to run the container;
(c) determining whether the instance of the malicious process was initiated by a code execution command associated with the orchestration object;
(d) determining whether the instance of the malicious process was initiated by a cloud level command; and
(e) determining whether the instance of the malicious process resulted from a runtime exploitation based on timing of the security event relative to a container start time.

19. The system of claim 18, the series of steps further comprising executing a security patch based on the root cause.

20. A non-transitory computer readable medium having instructions thereon, the instructions, when executed by a computer, causing the computer to perform operations for determining a root cause of a security alert associated with a containerized software application, the operations comprising:
(a) receiving and analyzing the security alert to detect an instance of a malicious process, the security alert comprising an automated notification generated in response to a detected security threat associated with the containerized software application;
(b) determining whether the instance of the malicious process is present in an image of a container running the containerized software application;
(c) determining whether the instance of the malicious process is present in an orchestration object configured to run the container;
(d) determining whether the instance of the malicious process was initiated by a code execution command associated with the orchestration object;
(e) determining whether the instance of the malicious process was initiated by a cloud level command;
(f) determining whether the instance of the malicious process resulted from a runtime exploitation based on timing of the security alert relative to a container start time;
determining the root cause of the security alert associated with the containerized software application by starting at (a) and successively advancing through one or more of (a)-(e) until the root cause is determined; and
facilitating execution of a security patch based on the root cause.
